(19) United States
(12) Patent Application Publication
(10) Pub. No.: US 2017/0200115 A1
(43) Pub. Date: Jul. 13, 2017

(54) SYSTEMS AND METHODS OF CONSOLIDATING PRODUCT ORDERS

(71) Applicant: Wal-Mart Stores, Inc., Bentonville, AR (US)

(72) Inventors: Donald R. High, Noel, MO (US); Michael D. Atchley, Springdale, AR (US)

(21) Appl. No.: 15/400,056

(22) Filed: Jan. 6, 2017

Related U.S. Application Data
(60) Provisional application No. 62/275,886, filed on Jan. 7, 2016.

(51) Int. Cl. G06Q 10/08; G06K 9/00; G01C 21/34; G01C 21/36; G06Q 30/06; G06Q 10/10

(52) U.S. Cl. CPC G06Q 10/083; G06Q 30/0633; G06Q 10/103; G01C 21/343; G01C 21/3664; G06K 9/00671; G02B 27/017

(57) ABSTRACT

In some embodiments, apparatuses and methods are provided herein useful to fulfill product orders. In some embodiments, a product order fulfillment system is provided that comprises: a plurality of optical head-mounted display (OHMD) systems; and a customer order fulfillment system comprising a consolidation management circuit to: receive multiple product orders; obtain an identifier of each of the picked products in association with a pick container identifier of a respective one of the pick containers in which the picked product is located; identify a pick container identifier in which the ordered product is located; communicate to an OHMD system a consolidation listing identifying requested products, the corresponding pick container identifier, and for each of the listed requested products a delivery bin identifier of a delivery bin into which the requested product is to be deposited, and cause the consolidation listing to be displayed on the OHMD system.

### CROSS-REFERENCE TO RELATED APPLICATION

This application claims the benefit of U.S. Provisional Application No. 62/275,886, filed Jan. 7, 2016, which is incorporated herein by reference in its entirety.

### TECHNICAL FIELD

This invention relates generally to fulfilling product orders.

### BACKGROUND

In a modern retail environment, there is a need to improve the customer service and/or convenience for the customer. One aspect of customer service is providing customers with access to products and/or the delivery of products. There are numerous ways to delivery products to customers. Collecting the ordered product, however, can cause undesirable delays, can add cost, and reduce revenue.

### BRIEF DESCRIPTION OF THE DRAWINGS

Disclosed herein are embodiments of systems, apparatuses and methods pertaining fulfilling product orders. This description includes drawings, wherein:

FIG. 1 illustrates a simplified block diagram of an exemplary product order fulfillment system, in accordance with some embodiments.

FIG. 2 illustrates an exemplary system for use in implementing systems, apparatuses, devices, methods, techniques and the like in consolidating products and controlling the delivery of products in accordance with some embodiments.

FIG. 3 illustrates a simplified block diagram of an exemplary Optical Head-Mounted Display (OHMD) system, in accordance with some embodiments.

FIG. 4 illustrates a simplified flow diagram of an exemplary process of fulfilling product orders through a retail store, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to fulfill product orders, typically from a shopping facility. Some embodiments include a product order fulfillment system that includes and/or is in communication with a plurality of Optical Head-Mounted Display (OHMD) systems that can be associated with and worn by workers at a shopping facility. The fulfillment system further includes a customer order fulfillment system, associated with a retail store or other shopping facility, that wirelessly communicates with each of the plurality of OHMD systems. One or more consolidation management circuits of the fulfillment system receive multiple different product orders for one or more requested products to be fulfilled at the retail store. The consolidation management circuit further obtains, for each of multiple different pick containers, an identifier of each picked products in association with a pick container identifier of a respective one of the pick containers in which the picked product is located. The picked products are products that were ordered by customers in multiple different product orders, and that were previously picked by workers at the retail store and were placed by the workers into the different picked products. A pick container identifier is identified for each ordered product in which the ordered product is located. A consolidation listing is communicated to at least one OHMD system associated with a worker. The consolidation listing identifies requested products corresponding to at least one product order, and a corresponding pick container identifier in which each of the requested products in the consolidation listing is located. Further, delivery bin identifier information is typically further communicated to the OHMD system for each of the listed requested products into which the requested product is to be deposited in preparation for delivery of the product orders to corresponding customers. The consolidation listing is further caused to be displayed on and/or audibly reproduced through at least one of the OHMD systems.

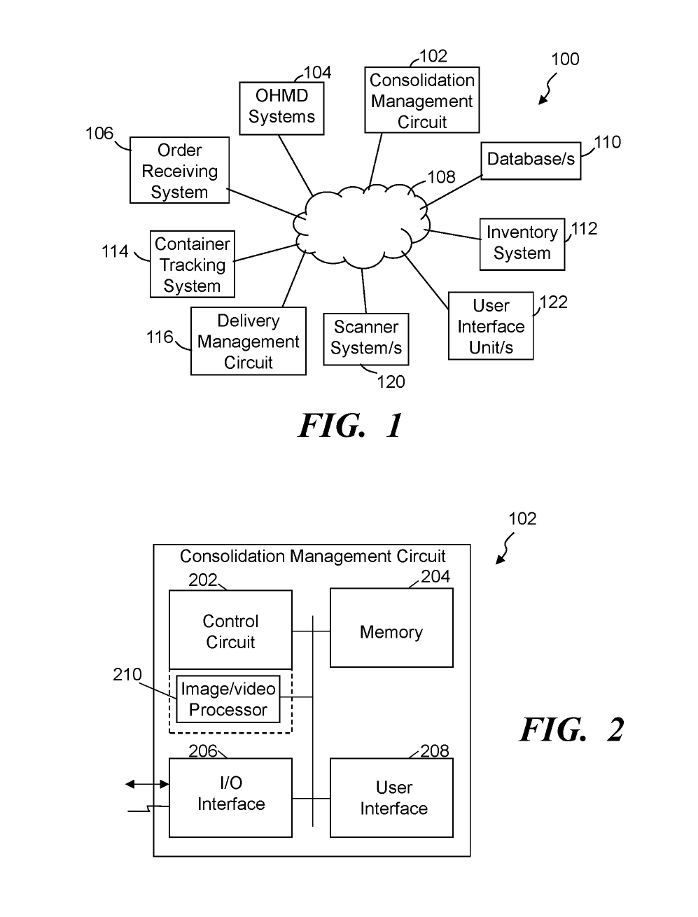

FIG. 1 illustrates a simplified block diagram of an exemplary product order fulfillment system 100, in accordance with some embodiments. The product order fulfillment system includes one or more consolidation management circuits (CMC) 102, a plurality of OHMD systems 104, and an order receiving system 106. In some applications the consolidation management circuit is communicatively coupled with one or more databases 110, and/or is part of a customer order fulfillment system that further includes and/or couples with one or more databases 110 and/or other electronic data storage components, which may store product information, customer information, product orders, retail store and product placement mapping, product identifier information, inventory information, and/or other such information. The consolidation management circuit 102 is communicatively coupled with the OHMD systems 104, the order receiving system 106, and one or more databases 110 through one or more wired and/or wireless distributed communication networks 108 (e.g., one or more wired and/or wireless LANs, WANs, Internet, etc.). In some embodiments, the system may optionally include and/or communicatively couple with one or more inventory systems 112, one or more container tracking systems 114, one or more delivery management circuit (DMC) 116, one or more scanner systems 120, one or more user interface units 122, and other relevant systems. In some implementations, the consolidation management circuit 102 and the delivery management circuit 116 may be cooperated into a single circuit or system.

In some embodiments, the product order fulfillment system 100 is associated with a single retail store that customers enter and shop themselves for products, which are on display and/or for sale and variously distributed throughout a sales floor within the retail store. In other embodiments, the fulfillment system may utilize and/or be distributed over multiple retail stores. Typically, a single customer order is fulfilled through a single one of the retail stores. In some situations, however, a single customer order may be fulfilled through more than one retail store (e.g., when a first retail store does not have one or more ordered products). The fulfillment of the orders, however, are typically fulfilled through one or more retail stores instead of a distribution center, fulfillment warehouse, or the like. The retail store can be substantially any type of shopping facility at a location in which products for display and/or for sale are variously distributed throughout the shopping facility space. The facility may be any size of format facility, and may include products from one or more merchants. For example, a facility may be a single store operated by one merchant or may be a collection of stores covering multiple merchants such as a mall.

The one or more consolidation management circuits 102 implement instructions stored in memory. In some embodiments, the consolidation management circuit 102 receives multiple different product orders to be fulfilled at the retail store. Typically, the product orders are received from customers through an order receiving system 106. The order receiving system may, in some applications, be accessed by customer's using computers, laptops or other user interface units to identify one or more products, from hundreds to hundreds of thousands or millions of different products, to be purchased as part of a customer order. For example, the order receiving system may be in communication with, associated with and/or included as part of an Internet ecommerce site that allows customer to purchase products. The order receiving system may further be in communication with a POS system that confirms payment and completion of a customer order.

Based on the multiple product orders, the consolidation management circuit 102 directs the separation and consolidation of previously picked items that were retrieved by workers as they moved through the retail store and collected the ordered products for multiple different product orders. Typically, one or more workers are directed to follow separate product collection routes through the retail store to collect the requested products for the multiple different product orders. For example, multiple orders may be received each requesting one or more products. Locations of the different products in the retail store are obtained and/or determined. The collection of products can be implemented in accordance with some embodiments through systems and methods described in U.S. Provisional Patent Application No. 62/275,871, by Donald R. High et al., entitled SYSTEMS AND METHODS OF FULFILLING PRODUCT ORDERS, and U.S. patent application Ser. No. 15/398,103, filed Jan. 4, 2017, and entitled SYSTEMS AND METHODS OF FULFILLING PRODUCT ORDERS, which are incorporated herein by reference in their entirety. In some implementations, the picked products are placed into one or more pick containers. For example, each worker picking products for the multiple different product orders places the picked products into the pick containers that the workers transport through the retail store while picking products. Typically, the collection routes are determined such that each of the one or more workers, while retrieving products along a single product collection route, retrieves products from at least two of the multiple different product orders. Accordingly, the each pick container often includes products for different product orders. The consolidation management circuit, at least in part, directs workers in consolidating products into the corresponding product orders to be delivered and/or picked up by the customer.

In some embodiments, the consolidation management circuit, in directing the consolidation of products, obtains an identifier of each of the picked products in association with a pick container identifier of one or more pick containers in which the picked product are located. Again, the multiple different picked products for the multiple different product orders were each deposited by the one or more workers into one of the multiple different pick containers. Each of the pick containers has an identifier and/or can be distinguished. Further, the consolidation management circuit can further provide pick container identifier information to the workers in consolidating the product orders. In some implementations, the consolidation management circuit identifies, for each ordered product, a pick container identifier in which the ordered product is located. For example, for each particular product order, the consolidation management circuit identifies each product of the order, identifies in which of the pick containers each of the ordered products is placed, and generates and/or obtains a consolidation listing that identifies the requested products corresponding to the product orders, and the corresponding pick container identifier in which each of the requested products is located.

The consolidation management circuit 102 communicates to one or more OHMD systems, each associated with a worker, a consolidation listing or a portion of a consolidation listing identifying the requested one or more products corresponding to an product order and the corresponding pick container identifier in which each of the requested products is located. In some embodiments, the consolidation listing further identifies and/or specifies, for each of the listed requested products, a delivery bin or container identifier into which the requested product is to be deposited by the worker in preparation for delivery of the product order to a corresponding customer. The consolidation listing is caused to be displayed and/or audibly reproduced through the one or more OHMD system 104. This allows the worker to perform the consolidation without having to pick up a printed list or look at a separate display (e.g., the display of a handheld user interface unit 122). Accordingly, the time to consolidate products can be reduced, while improving the accuracy of the consolidation.

In some embodiments, the consolidation management circuit further identifies a number of workers that are to be assigned and/or tasked with performing the consolidation of the ordered products in accordance with the different product orders. The number of workers can affects the number of consolidation listings to be determined, the organization of pick containers and/or delivery bins, a number of products to be consolidated by each of the assigned workers, and other such factors. Accordingly, the consolidation management circuit typically identifies a number of workers to be tasked with consolidating products. The number of workers can depend on worker availabilities, number of products to be consolidated, number of product orders, size and/or weight of products ordered, quantities of products in each product order, easy of transport of products ordered, other such factors, and typically a combination of two or more of such factors.

Further in some embodiments, the consolidation management circuit in defining the consolidation lists may attempt to minimize the number of delivery bins each product order utilizes. Additionally, in some applications, the consolidation management circuit may prevent and/or restrict the combining of certain products and/or the placement of certain products in the same delivery bin. It is noted, however, that more than one worker may consolidate products for the same product order, while typically placing those products into separate delivery bins.

The consolidation management circuit 102 can identify OHMD systems 104 that are assigned to and/or associated with the one or more workers that are to be assigned to and/or are available to be assigned to consolidate at least one of the one or more products. Typically, a worker that may be assigned to consolidate products is assigned a particular OHMD system, and the assignment is stored in the consolidation management circuit, database 110, a task management system, and/or other such system that is in communication with the consolidation management circuit. The OHMD systems are configured to be in wireless communication with the consolidation management circuit.

Accordingly, the consolidation management circuit 102 wirelessly communicates consolidation listings corresponding to each of the OHMD systems 104 associated with each of the identified one or more workers who are to consolidate products. The consolidation management circuit causes at least a portion of the consolidation listing to be visually displayed and/or audibly reproduced through the respective one of the plurality of OHMD systems worn by each of the one or more workers. Again, the consolidation listing can include product identifier information of one or more products, pick container identifier information, and/or delivery bin identifier information.

In some embodiments, the OHMD systems 104 include a location detection system that identifies a current location of the OHMD system and/or communicates information to the consolidation management circuit, the delivery management circuit, a mapping system, and/or an OHMD system location tracking system that can identify current locations of the OHMD systems and/or track movements of the OHMD systems. In some applications, the consolidation management circuit receives location information of the corresponding OHMD systems and communicates portions of the consolidation listing with products that are within a collection threshold distance of the current location of the OHMD system, product information for one or more products that are within a product threshold distance, which may be the same distance or a different distance than the collection threshold distance, for a threshold number of products, and the like. The consolidation management circuit may further consider other factors in determining an amount of the consolidation listing and/or product information that is communicated, such as but not limited to a total number of products to be consolidated, number of product orders to be consolidated, number of products in one or more product orders, a total distance to be traveled by a worker in consolidating, number of pick containers to collect from, locations of pick containers, a worker's experience in consolidating products, a worker's historic efficiency in consolidating products, other such factors, or combination of two or more of such factors.

Additionally or alternatively, the OHMD systems 104 may limit the amount of the consolidation listings and/or product information that is displayed based on the one or more factors (e.g., display real estate, number of products to consolidate, rate at which the worker is consolidating, worker's experience in consolidating, worker's history, etc.). Still further, in some implementations the worker, through interfacing with the OHMD system 104, may be able to control an amount of the consolidation listing and/or product information that is provided to the OHMD system and/or displayed through the OHMD system. For example, the worker may be able to zoom out to view more of the product listing and/or product information. As such, in some embodiments, the consolidation management circuit may communicate some or the entire consolidation listing and/or product information allowing the worker and/or the OHMD system to control the amount of the consolidation listing and/or product information that is displayed and/or audible reproduced for the worker through the OHMD system.

In some embodiments, the consolidation management circuit may provide additional assistance to the worker in identifying pick containers and products to be collected. Similarly, the consolidation management circuit may provide additional assistance to workers in identifying delivery bins into which one or more products are to be placed. For example, the consolidation management circuit may distinguish one or more pick containers from which one or more products are to be retrieved. This distinguishing can be through displaying a highlighting and/or a displayed different color overlay in the field of view of the worker where the pick container is located. In some applications, the OHMD systems capture images and/or video. The images and/or video can be processed by the OHMD system and/or forwarded to the consolidation management circuit (and/or a separate image processing and/or video processing system). One or more pick containers can be identified and their locations within the field of view of the worker can be determined. With this information, the OHMD system and/or the consolidation management system can cause one or more distinctions to be displayed (e.g., change of coloring, a circle displayed around a pick container of interest, or the like) in the field of view of the worker that distinguishes one or more pick containers from which the worker is to retrieve a product in a product order. Similar distinctions can be displayed to identify one or more products within a pick container that aids the worker is selecting a product. Further, delivery bins can be highlighted.

In some implementations, the consolidation management circuit 102 receives one or more images and/or video from an OHMD system 104 of a pick container. Based at least in part on the one or more images and/or video, a pick container and/or each of multiple different products within a pick container can be detected and identified. The consolidation management circuit can cause the OHMD system to display a highlighting that visually distinguishes one or more products of the multiple different products within the pick container that corresponds to a requested product identified in the consolidation listing. Similar distinctions and/or displayed guidance can be displayed based on a current location and field of view visible to the worker.

Some embodiments may further provide the assigned workers with information regarding a number of delivery bins and/or types of delivery bins into which the worker is to deposit one or more products. For example, some delivery bins may be insulated and intended to receive products that are to be maintained within a range of one or more threshold temperatures. Similarly, a delivery bins may include a cooling system and/or heating system, and products that are to be collected that are to be maintained at or within a threshold range of a specified temperature may be inserted into one of these delivery bins. Further, in some instances and/or for one or more products, the consolidation management circuit further has access to information regarding dimensions, weight and other information about products to be consolidated. The consolidation management circuit can determine a number, size and/or type of delivery bin to be used by the worker in consolidating the one or more assigned products based on the dimensions, weight, type of delivery vehicle, and other such factors. The number, size and/or type of one or more delivery bins that the worker is to use can similarly be communicated to and caused to be displayed and/or audibly reproduced to the worker prior to and/or as the worker is implementing the consolidation. In some applications, the consolidation management circuit and/or the OHMD system may further verify the size, type and/or number of delivery bins a worker uses and/or into which a particular product is placed (e.g., based on video and/or image processing, detection of product container identifiers (e.g., bar code), and/or other such methods). A notification can be displayed and/or audibly generated through the OHMD system when an incorrect bin, bin type, size, and/or number of product containers are retrieved.

Further, in some embodiments, the consolidation management circuit and/or OHMD system can confirm a correct product is placed in a correct delivery bin. For example, the consolidation management circuit can receive product data from an OHMD system and identify from the product data a product retrieved by the worker from a pick container. The product data can include, but is not limited to, a scan of a bar code, detection of an RFID, an image of the product that is used to identify the product through image recognition, other such information, or combination of two or more of such information. The pick container may further be identified (e.g., based on a bar code, shape of the container, placement of the container, etc.). The consolidation management circuit and/or OHMD system can confirm the product identifier information is consistent with a requested product identified in the consolidation listing. Similarly, the consolidation management circuit and/or OHMD system may additionally or alternatively receive delivery bin data from the OHMD system and identify from the delivery bin data a delivery bin into which the worker is placing the identified product. Once identified, the consolidation management circuit and/or OHMD system can confirm the product is placed into the correct delivery bin consistent with and as identified in the consolidation listing.

Some embodiments may further prevent combining certain products in the same delivery bin and/or in the same bag when inappropriate. For example, product typically should not be included in a bin with cleaning products. Similarly, a crush factor may be considered relative to one or more products, such as considering weight of one product relative to a crushability and/or fragile factor (e.g., canned goods should not be included in a delivery bin with eggs, bread, or the like, unless there is a way to maintain a position of the canned goods). The consolidation management circuit can obtain product identifier information of a product retrieved by the worker corresponding to the consolidation listing. A delivery bin into which the product is to be placed can be identified. The OHMD system can be caused to generate a notification (e.g., audible and/or visual) that notifies the worker that the retrieved product cannot be placed in a delivery bin with one or more other products already in the delivery bin.

In some instances, one or more of the assigned workers may be unavailable (e.g., helping a customer, in the middle of another task, etc.). Accordingly, the worker may be able to response through the OHMD system that she/he is unavailable. The consolidation management circuit can then reevaluate the workers, customer orders, and the like in assigning a different worker and/or redefining consolidation listings and products to be collected by one or more workers. Additionally or alternatively, the consolidation management circuit may modify a worker's consolidation listing of products.

Some embodiments may update one or more consolidation listings and product information based on one or more workers' movements through the retail store. The consolidation management circuit 102 and/or the OHMD system 104 determine and/or receive location information associated with each of the OHMD systems associated with the one or more workers. This location information may be based on video and/or image processing of video and/or images captured by one or more cameras in the retail store, and/or video and/or image processing from video and/or images captured by one or more cameras of an OHMD system. Further, in some implementations the OHMD system may include a global positioning system (GPS) that can receive and track location information based on received GPS coordinates. In some embodiments, the OHMD system may include movement sensors (e.g., inertial sensors, motion sensors, distance measurement sensors, compass, and/or other such sensors) that can be used to determine location and/or track movements of the OHMD system. The OHMD system may further include one or more light detectors to detect the light from the lighting system that includes one or more light units that emit light with information encoded into the emitted light, which may include light source identifier information, area identifier or number, location information, and/or other such information or combination of such information. This information can be used by the OHMD system and/or communicated to the consolidation management circuit to be used in determining and/or tracking a location of the OHMD system. In some applications, the OHMD system includes a machine readable code reader that can detect machine readable codes and/or can capture images of machine readable codes that are spaced at predefined locations in the retail store that can be used to determine a current location. Other methods of tracking movement can be used, including but not limited to triangulation based on wireless signals and sources of wireless signals, tracking rotations of wheels of an item container, and other such methods.

Based on the location information, the consolidation management circuit and/or the OHMD system may identify one or more subsequent products to be consolidated, delivery bins to be retrieved and/or into which a product is to be placed, one or more delivery vehicles into which a delivery bin is to be placed, relevant compartments of a delivery vehicle into which a delivery bin is to be placed, or the like. When determined by the consolidation management circuit, the consolidation management circuit can cause updated information, further product identifier information, vehicle information and the like corresponding to the subsequent product based on the location information to be communicated to a corresponding OHMD system, and cause the updated information to be displayed on correspond ones of the OHMD systems associated with the one or more workers.

Some embodiments further track products as they are retrieved by workers and may further track into which delivery bin the worker places the product. Again, the workers typically consolidate orders of products multiple pick containers that contain products for multiple different product orders. As such, the workers have to identify a correct pick container and the correct product and number of products to remove from the pick container. Further, the workers have to accurately place the products into correct delivery bins. Accordingly, the fulfillment management circuit may track the placement of the products into different delivery bins.

In some applications, the consolidation management circuit 102 and/or delivery management circuit 116 receive images and/or video data captured by one or more of the OHMD systems 104 associated with one of the workers while the one or more workers are consolidating products and/or loading a delivery vehicle. From the image data, the consolidation management circuit and/or delivery management circuit can identify pick containers from which products are to be retrieved, identify into which of a plurality of delivery bins a worker is to place products of one or more orders retrieved from pick containers, identify a delivery vehicle into which a delivery bin is to be placed, and the like. A listing of the products in a pick container and/or in one or more delivery bins can be maintained at the consolidation management circuit, a database, order receiving system and/or other such system.

Additionally, in some instances, the OHMD system can display to a worker the list of products in a particular pick container and/or delivery bin. The consolidation management circuit and/or the OHMD system may identify a pick container or delivery bin (e.g., based on image processing, detecting a container or bin identifier, an RFID signal, an optically readable code, and/or other such information). The consolidation management circuit can one or more listings to be displayed on and/or audibly reproduced by an OHMD system that each identifies the products in a pick container and/or that have been placed into a delivery bin.

Some embodiments may further identify products being placed into the one or more delivery bins and can verify that the products placed into the bins are those that are in the customer order. In some instances, the product may be identified through RFID detected by the OHMD system or other RFID detector, optical scan of a bar code or other such identifier code, image processing of an image of the product, and/or other such methods or combination of two or more of such methods. The identification can further include obtaining additional information from an inventory system, or other system. Once identified, the product can be cross referenced with a product order and confirmed that the product is the ordered product. As such, the system can validate each product placed into a delivery bin. Similarly, the consolidation management circuit and/or OHMD system may identify a delivery bin into which a product is being placed and confirm that the product is placed into a correct bin. An error notification can be displayed and/or audible produced at the OHMD system when an incorrect product is retrieved and/or placed into an incorrect delivery bin.

The products for each product order are consolidated into one or more delivery bins and prepared to be delivered and/or picked up at the retail store by the customers. Some embodiments further optimize the loading of delivery bins into one or more delivery vehicles. In some applications, the product order fulfillment system 100 includes one or more delivery management circuits 116 that determine a delivery route and identify a sequence of delivery of the multiple product orders associated with each of one or more delivery vehicles to perform delivery of the requested products for the multiple product orders. Delivery addresses are known based on the product order. The delivery address may be specified in a customer profile and/or specified by the customer in association with submitting the product order. Using the delivery addresses, the delivery management circuit determines one or more delivery routes to deliver the product orders. The one or more routes are determined based on a number of available delivery vehicles, estimated times to travel between delivery locations, number of products in a product order, types of products in a product order, cost of fuel in traveling between delivery locations, other such factors, or a combination of two or more of such factors.

The sequence of delivery of the multiple product orders is dependent on the one or more delivery routes. For each delivery route, a sequence of one or more deliveries is identified. A loading sequence of each of the delivery bins into the one or more delivery vehicles is determined to correspond with the multiple product orders and the sequence of delivery of those product orders. The delivery management circuit, the consolidation management circuit and/or a task management system can identify one or more relevant workers to perform the loading of the delivery bins into the one or more delivery vehicles, and cause relevant loading sequences to be wirelessly communicated to the OHMD systems 104 associated with those identified workers. The one more OHMD systems, in response to receiving one or more of the loading sequences and consistent with instructions from the delivery management circuit, display and/or audibly reproduce an order of loading, consistent with the load sequence, in which the delivery bins corresponding to the multiple product orders are to be loaded into the delivery vehicle.

The order of loading identifies a delivery bin and at least a corresponding delivery vehicle into which the delivery bin is to be placed. In some implementations, the delivery vehicles include one or more compartments or sections. These compartments can provide an organization of delivery bins, provide separate temperature controlled compartments, and the like. As such, the delivery sequence and the order of loading can further identify for one or more delivery bins the relevant compartment into which the delivery bin is to be placed. In some embodiments, the delivery sequence and order of loading identifies a compartment for each delivery bin, while in other instances, the compartment may be identified for only some of the delivery bins.

In some implementations, the loading order is reversed relative to the sequence of delivery for each of the delivery vehicles. Accordingly, the delivery bins are loaded into the delivery vehicle and/or the relevant compartments of a delivery vehicle in a first-in-last-out order. In this way, the delivery worker can more easily identify the delivery bin or bins corresponding to a delivery location and more easily retrieve the delivery bins. Further, the ordered loading in this reverse delivery order can reduce delivery errors. In some embodiments, the delivery management circuit 116 in determining the load sequence is further configured to determine the load sequence in a reverse order relative to the sequence of delivery such that one or more delivery bins associated with a product order scheduled to be delivered last are to be loaded into the delivery vehicle first, and one or more delivery bins associated with a product order scheduled to be delivered first are to be loaded into the delivery vehicle last.

Again, some products may have temperature restrictions (e.g., maintaining a product within a temperature threshold range, maintaining a product above or below a temperature threshold, and the like). As such, the binning of the products can include directing the workers to bin a product into corresponding temperature appropriate bins. Additionally or alternatively, the loading sequence can include directing a worker to appropriately load one or more bins into temperature compartments of delivery vehicle that maintain temperatures within threshold ranges. In some embodiments, the consolidation management circuit 102 causes a notification to be generated by one or more OHMD systems that notify the corresponding workers (e.g., display and/or audibly reproduce) that a product is to be placed in a delivery bin that corresponds to a product order and that corresponds to a threshold temperature at which the product is to be maintained. The delivery management circuit 116 may additionally or alternatively cause the one or more OHMD systems to display and/or audibly reproduce a compartment identifier of a compartment on the delivery vehicle consistent with the threshold temperature into which a delivery bin is to be placed. Accordingly, in some implementations, the one or more workers assigned to bin and/or load the one or more delivery vehicles are provided with specific directions regarding the order in which delivery bin are loaded, into which delivery vehicles the delivery bins are to be placed, and/or into which compartments delivery bins are to be placed.

Some embodiments may further assist the workers by highlighting and/or distinguishing a delivery bin to be loaded, a delivery vehicle into which a delivery bin is to be placed, and/or a compartment of the delivery vehicle a delivery bin is to be placed. The OHMD system, consolidation management circuit and/or delivery management circuit may identify a delivery bin, a delivery vehicle, and/or compartment of a delivery vehicle (e.g., based on a bar code or other identifier, a placement and/or orientation, image recognition, other such methods, or combination of two or more of such methods). An overlay, boarder, highlighting or the like can be caused to be displayed by the OHMD system consistent with a delivery bin, a delivery vehicle, and/or compartment.

Some embodiments may notify a worker when a product is placed into an incorrect delivery bin, when a delivery bin is loaded in incorrect delivery vehicle, and/or when a delivery bin is placed into an incorrect compartment of a delivery vehicle. In some implementations, the delivery management circuit 116 and/or an OHMD system receives delivery bin identifier information corresponding to one or more delivery bins, and identifies the one or more delivery bins (e.g., bar code read by the OHMD system, image of a bar code captured by the OHMD system, image recognition, RFID tag detected by the OHMD system or other reader associated with the worker and/or the OHMD system, or the like). The delivery management circuit and/or OHMD system may further obtain and/or determine a corresponding location of the delivery bin for subsequent consideration. The delivery management circuit may further receive delivery vehicle identifier information from the OHMD system corresponding to the delivery vehicle into which one of the identified delivery bins is being placed by a worker. Based on an evaluation of the delivery bin identifier and the product orders to be delivered by the identified delivery vehicle, the delivery management system and/or the OHMD system can verify that the delivery bin is intended to be placed into the delivery vehicle and/or an order in which the delivery bin is to be placed into the delivery vehicle. Similarly evaluations can confirm a compartment of the delivery vehicle. The delivery management circuit and/or OHMD system can further cause a notification to be generated by the OHMD system notifying the worker when the delivery bin is being incorrectly placed into the delivery vehicle. The notification can be a displayed and/or audibly produced notification.

In some applications, the delivery management circuit receives location information of the corresponding OHMD systems and communicates portions of the loading sequence, delivery sequence and the like that are within a threshold distance of the current location of the OHMD system, product information for one or more products that are within a product threshold distance, which may be the same distance or a different distance than the threshold distance, for a threshold number of products, and the like. The delivery management circuit may further consider other factors in determining an amount of the loading sequence, product information, delivery bin identifier information, delivery vehicle information, and/or compartment information that is communicated, such as but not limited to a total number of delivery bins to be loaded, total number of delivery vehicles, number of workers, a worker's experience, a worker's historic efficiency, other such factors, or combination of two or more of such factors. Additionally or alternatively, the OHMD systems 104 may limit the amount of the loading sequence that is displayed. Similarly, the worker, through interfacing with the OHMD system 104, may be able to control an amount of the loading sequence that is provided to the OHMD system and/or displayed through the OHMD system.

In some embodiments, the delivery management circuit 116 may provide additional assistance to the worker in identifying delivery bins, delivery vehicles, compartments of the delivery vehicle, and the like. For example, the delivery management circuit may distinguish one or more delivery bins that are to be loaded. The distinguishing can be through displaying a highlighting and/or a displayed different color overlay in the field of view of the worker where the delivery bin (or delivery vehicle, or compartment) is located. In some applications, the OHMD systems capture images and/or video. The images and/or video can be processed by the OHMD system and/or forwarded to the delivery management circuit (and/or a separate image processing and/or video processing system). A relevant delivery bin, vehicle, compartment can be identified and their locations within the field of view of the worker can be determined. With this information, the OHMD system and/or the delivery management system can cause one or more distinctions to be displayed (e.g., change of coloring, a circle displayed around a pick container of interest, or the like) in the field of view of the worker.

Further, in some embodiments, the delivery management circuit and/or OHMD system can confirm the correct loading of a delivery bin into a correct vehicle and/or compartment of a vehicle. For example, the delivery management circuit can identify or receive identifying information from an OHMD system of a delivery bin and/or a delivery vehicle. The identifying information can include, but is not limited to, a scan of a bar code, detection of an RFID, an image of the delivery bin, vehicle, part of the vehicle, etc. The delivery management circuit and/or OHMD system can confirm the delivery bin identifier information is consistent with the loading sequence, and that the delivery vehicle identifier information and/or compartment identifier information is consistent with the loading sequence. Further, the delivery of products according to product orders by delivery vehicles in accordance with some implementations is described in U.S. Provisional Application No. 62/275,891, for Donald R. High et al., entitled SYSTEMS AND METHODS OF ASSISTING IN THE DELIVERY OF PRODUCTS, which is incorporated herein by reference in its entirety.

The methods, techniques, systems, circuits, devices, services, servers, sources and the like described herein may be utilized, implemented and/or run on many different types of devices and/or systems. Referring to FIG. 2, there is illustrated an exemplary system 200 that may be used for any such implementations, in accordance with some embodiments. For example, one or more components of the system 200 may be used to implement any circuit, system, apparatus or device mentioned above or below, or parts of such circuits, systems, apparatuses or devices, such as for example any of the above or below mentioned consolidation management circuit 102, delivery management circuit 116, order receiving system 106, container tracking system 114 (which may maintain location information of pick containers, delivery bins, and/or other such item containers), inventory systems 112, scanner system 120, user interface unit 122, and the like. However, the use of the system 200 or any portion thereof is certainly not required.

By way of example, the system 200 may include one or more control circuits 202, memory 204, and input/output (I/O) interfaces and/or devices 206. Some embodiments further include one or more user interfaces 208. The control circuit 202 typically comprises one or more processors and/or microprocessors. The memory 204 stores the operational code or set of computer instructions that is executed by the control circuit 202 and/or processor to implement the functionality of the consolidation management circuit 102, delivery management circuit 116, order receiving system 106, container tracking system 114, inventory systems 112, scanner system 120, user interface unit 122, and the like. Additionally, in some applications, the fulfillment management circuit includes and/or couples with one or more image and/or video processors 210 that provide image processing of at least images, which may include video processing, captured by one or more cameras of the OHMD systems 104, the retail store, and/or other cameras. The system 200 typically includes a power supply (not shown), which may be rechargeable, and/or it may receive power from an external source. While FIG. 2 illustrates the various components being coupled together via a bus, it is understood that the various components may actually be coupled to the control circuit 202 and/or one or more other components directly. In some embodiments, the memory 204 may also store some or all of particular data that may be needed to provide consolidation listings, identify pick containers, identify delivery bins, identify delivery vehicles, identify compartments of delivery vehicles, confirm products, confirm placement of products, and make any of the detections, associations, determinations, measurements and/or communications described herein. Such data may be pre-stored in the memory, received from an external source, be determined, and/or communicated to the system.

It is understood that the control circuit 202 and/or processor may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the system 200; however, the memory 204 can be internal, external or a combination of internal and external memory.

Generally, the control circuit 202 and/or electronic components of the system 200 can comprise fixed-purpose hard-wired platforms or can comprise a partially or wholly programmable platform. These architectural options are well known and understood in the art and require no further description here. The system and/or control circuit 202 can be configured (for example, by using corresponding programming as will be well understood by those skilled in the art) to carry out one or more of the steps, actions, and/or functions described herein. In some implementations, the control circuit 202 and the memory 204 may be integrated together, such as in a microcontroller, application specification integrated circuit, field programmable gate array or other such device, or may be separate devices coupled together.

The I/O interface 206 allows wired and/or wireless communication coupling of the system 200 to external components and/or or systems. Accordingly, the I/O interface 206 may include any known wired and/or wireless interfacing device, circuit and/or connecting device, such as but not limited to transceivers, receivers, transmitters, and the like. For example, in some implementations, the I/O interface 206 provides wireless communication in accordance with one or more wireless protocols (e.g., Wi-Fi, Bluetooth, cellular, radio frequency (RF), other such wireless communication, or combinations of such communications).

The user interface 208 may be used for user input and/or output display. For example, the user interface 208 may include any known input devices, such one or more buttons, knobs, selectors, switches, keys, touch input surfaces, audio input, and/or displays, etc. Additionally, the user interface 208 includes one or more output display devices, such as lights, visual indicators, display screens, etc. that can convey information to a user, such as but not limited to product information, consolidation listings, pick container identifying information, delivery bin identifying information, delivery vehicle information, compartment information, loading sequence, an order of loading, location information, status information, notifications, errors, conditions, and/or other such information. Similarly, the user interface 208 in some embodiments may include audio systems that can receive audio commands or requests verbally issued by a user, and/or output audio content, alerts and the like.

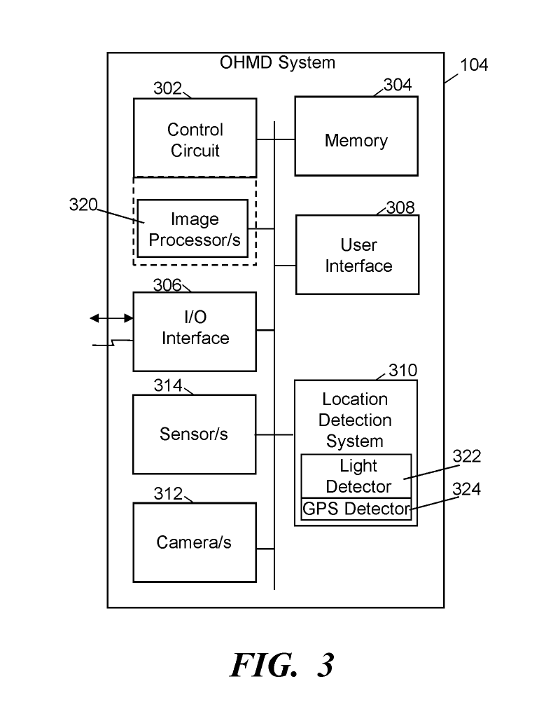

FIG. 3 illustrates a simplified block diagram of an exemplary OHMD system 104, in accordance with some embodiments. The OHMD system includes one or more OHMD control circuits 302, one or more memory 304, one or more input/output (I/O) interfaces and/or devices 306, and one or more user interfaces 308. Some embodiments further include one or more location detection systems 310, one or more cameras 312, one or more sensors 314, and/or other such systems and/or circuitry. Additionally, the OHMD system typically includes one or more power supplies (not shown), where one or more of such power supplies may be rechargeable, and/or the OHMD system may at least temporarily receive power from an external source. While FIG. 3 illustrates the various components being coupled together via a bus, it is understood that the various components may actually be coupled to the OHMD control circuit 302 and/or one or more other components directly.

The OHMD control circuit 302 typically comprises one or more processors and/or microprocessors and couples with the memory 304 that stores operational codes or sets of computer instructions that are executed by the OHMD control circuit 302 and/or processor to implement the functionality of the OHMD system 104. For example, in some applications, the OHMD control circuit may include and/or couple with one or more image processors 320 that provide image processing of at least images, which may include video processing, captured by one or more cameras 312 of the OHMD system 104. In some embodiments, the memory 304 may also store some or all of particular data that may be needed to at least provide the worker with the consolidation listings, and order of loading information. The system may further provide sequence of delivery information, loading sequence information, product information, delivery vehicle information, compartment information, other such information, and in some applications a combination of two or more of such information.

It is understood that the OHMD control circuit 302 may be implemented as one or more processor devices as are well known in the art. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the OHMD system 104; however, the memory 304 can be internal, external and wirelessly accessible, or a combination of internal and external memory.

Generally, the OHMD control circuit 302 and/or electronic components of the OHMD system 104 can comprise fixed-purpose hard-wired platforms or can comprise a partially or wholly programmable platform. These architectural options are well known and understood in the art and require no further description here. The OHMD system and/or OHMD control circuit 302 can be configured (for example, by using corresponding programming as will be well understood by those skilled in the art) to carry out one or more of the steps, actions, and/or functions described herein. In some implementations, the OHMD control circuit 302 and the memory 304 may be integrated together, such as in a microcontroller, application specification integrated circuit, field programmable gate array or other such device, or may be separate devices coupled together.

The I/O interface 306 allows wired and/or wireless communication coupling of the OHMD system 104 to external components, such as the consolidation management circuit 102, the delivery management circuit 116, bin tracking system 114, inventory system 112, user interface units 122 (e.g., smart phone, tablet, other OHMD system, smart watch systems, and other such consumer electronic user devices), databases 110, scanner systems 120, and other such devices or systems. Typically, the I/O interface 306 provides at least wireless communication (e.g., cellular, Wi-Fi, Bluetooth, RF, and/or other such wireless communication), and in some instances may include any known wired and/or wireless interfacing device, circuit and/or connecting device, such as but not limited to one or more transmitter, receiver, transceiver, etc.

The OHMD system further includes one or more user interfaces 308 that can be used for user output and/or input. For example, the user interface 308 may include any known input devices, such one or more buttons, knobs, selectors, switches, keys, touch input surfaces, audio input, and/or displays, audio detector to receive spoken commands, etc. Additionally, the user interface 308 includes one or more display projection systems and corresponding display surfaces (e.g., lens(es) of glasses), lights, visual indicators, etc. to convey information to a worker. Similarly, the user interface 308 in some embodiments may include audio systems that can receive audio commands or requests verbally issued by a worker, and/or output audio content, instructions, alerts and the like.

The OHMD systems 104 typically further include one or more cameras 312 that capture images and/or video that can be evaluated by the OHMD control circuit 302 and/or communicated to the consolidation management circuit 102, delivery management circuit 116, or the like for processing, and/or other systems. In operation, the OHMD control circuit 302 can activate one or more of the cameras 312. In some embodiments, one or more pictures and/or video captured by the camera/s 312 of the OHMD system can be evaluated for one or more parameters, rules and/or conditions as described above.

The location detection system 310 determines and/or obtains location information to determine a current location of and/or track the location and movements of the OHMD system. In some embodiments, the OHMD control circuit 302 and/or the consolidation management circuit 102 or delivery management circuit 116 can utilize the location information, for example, in determining products to retrieve from pick containers, identifying bin containers, confirming products consolidated, select portions of the consolidation listing, loading sequence, and/or product information to display and/or audibly reproduce, when to display identifiers and/or highlight products, pick containers, delivery bins, delivery vehicles, providing directional information to the worker, and the like. Similarly, as described above the consolidation management circuit and/or the delivery management circuit additionally can use the location information communicated from the OHMD system (e.g., determine portions of or all of the consolidation listings, loading sequence, an sequence of delivery, product information, updating consolidation listings and/or product information, tracking consolidation progress, confirming accuracy (e.g., of retrieved products, bins, delivery vehicles, compartments, etc.), and the like.

In some instances, the location detection system 310 may include a global positioning detection system or circuit 324 that received global positioning coordinate information, Wi-Fi signal triangulation and/or evaluation system, cellular tower triangulation system, and/or other such location detection system. In some embodiments, the location detection system 310 includes and/or couples with one or more light detectors 322 that detect and/or decode encoded information from lights in the retail store, where the lights are at known locations, and/or other such location information acquisition systems. Further, the location detection system may use information provided by one or more sensors 314 in determining and/or tracking location information. The sensors can include substantially any relevant sensor such as, but not limited to, one or more inertial sensors, accelerometers, gyroscopes, compass, distance measurement systems (e.g., ultrasound, laser, etc.), and/or other such sensor information. The OHMD system 104 may include one or more additional or alternative sensors 314 that provide information that may be used for location detection, such as but not limited to wireless signal strength sensor, and the like.

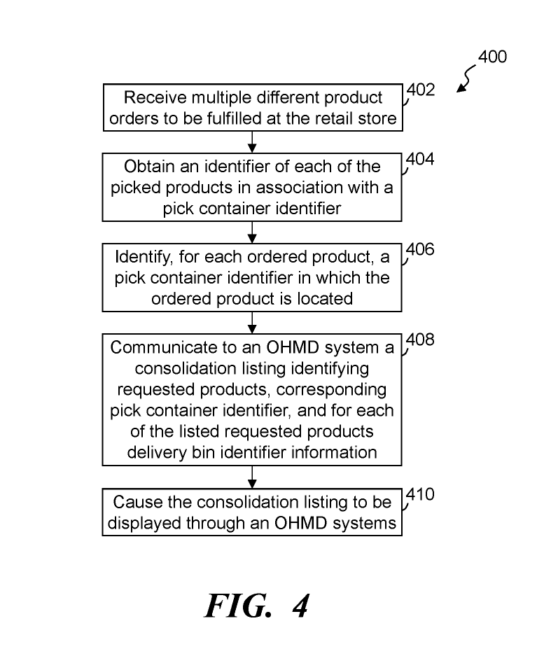

FIG. 4 illustrates a simplified flow diagram of an exemplary process 400 of fulfilling product orders through a retail store, in accordance with some embodiments. In step 402, multiple different product orders to be fulfilled at the retail store are received at a consolidation management circuit 102 and/or the delivery management circuit 116 of a product order fulfillment system 100 associated with a retail store. Again, in some applications, the customer orders are initially compiled and/or received through an order receiving system 106 that forwards the customer orders to be fulfilled to the consolidation management circuit 102 and/or the delivery management circuit 116.

In step 404, an identifier of each of picked product is obtained in association with a pick container identifier of a respective one of the pick containers in which the picked product is located. Again, multiple different products for the multiple different product orders are collected at the retail store by one or more workers and are deposited by the workers into multiple different pick containers. As such, products are consolidated from the pick containers into one or more delivery bins in consolidating each respective products order.

In step 406, for each ordered product, a pick container identifier in which the ordered product is located is identified. In step 408, a consolidation listing is communicated to one or more OHMD systems each associated with a worker. The consolidation listing identifies requested products corresponding to a product order, and the corresponding pick container identifier in which each of the requested products is located. Typically, the consolidation listing further identifies, for each of the listed requested products, delivery bin identifier information of a delivery bin into which the requested product is to be deposited in preparation for delivery of the product order to a corresponding customer. In step 410, the consolidation listing is caused to be displayed and/or audibly reproduced on the OHMD system 104.

In some embodiments, an ordered product to be retrieved from a pick container is visually distinguished or highlighted to a worker. For example, one or more images may be received from an OHMD system of a pick container. Based at least in part on the image, each of multiple different products that are within the pick container are identified. The OHMD system is caused to display a highlighting that visually distinguishes a product of the multiple different products within the first pick container that corresponds to a requested product identified in the consolidation listing. Some embodiments further confirming that a correct product is placed in a correct delivery bin. Product data can be received from an OHMD system. From the product data the product can be identified that was retrieved by the worker from the pick container. The product identifier information is confirmed to be consistent with a requested product identified in the consolidation listing. Further, some embodiments may receive delivery bin data from the OHMD system and identify from the delivery bin data a delivery bin into which the worker is placing the retrieved product. The consolidation management circuit can confirm that the product placed into the delivery bin is consistent with and as identified in the consolidation listing.

Further, some embodiments prevent combining one or more products with another product and/or combining certain products in the same delivery bin and/or a bag. The consolidation management circuit may obtain product identifier information of a product retrieved by the worker corresponding to the consolidation listing, and identify a delivery bin into which the first product is to be placed. Further, the consolidation management circuit can cause a notification to be generated by the OHMD system notifying the worker that the product cannot be placed in the delivery bin with one or more other products already in the delivery bin.

Some embodiments optimize the loading of a delivery by determining a delivery route associated with a delivery vehicle to perform the delivery of the requested products for multiple product orders. A sequence of delivery of the multiple product orders is identified from the delivery route. A loading sequence is determined for each of the delivery bins corresponding to the multiple product orders and the sequence of delivery. An OHMD system is caused to display an order of loading, consistent with the load sequence, in which the delivery bins corresponding to the multiple product orders are to be loaded into the delivery vehicle. Further, the loading order is often reversed relative to the delivery sequence. As such, the load sequence is determined in reverse order relative to the sequence of delivery such that one or more delivery bins associated with a product order scheduled to be delivered last are to be loaded into the delivery vehicle first, and one or more delivery bins associated with a product order scheduled to be delivered first are to be loaded into the delivery vehicle last.

Typically, the consolidation management circuit identifies products that are to be maintained at or between one or more temperature thresholds and directs the binning of products in corresponding temperature appropriate bins. Similarly, the loading sequence can further direct the loading into appropriate temperature compartments of a delivery vehicle. In some embodiments, the consolidation list is communicated and causes a notification to be generated by an OHMD system notifying a corresponding worker that a product is to be placed in a delivery bin that corresponds to a product order and that corresponds to a threshold temperature at which the product is to be maintained. Additionally or alternatively, the OHMD system can be caused to display the order of loading and a compartment identifier of a compartment on the delivery vehicle consistent with the threshold temperature into which the delivery bin is to be placed. Some embodiments may further notify a worker when delivery bin is loaded into an incorrect delivery vehicle and/or compartment. For example, delivery bin identifier information can be received from an OHMD system and/or determined from information provided by the OHMD system. The delivery bin identifier information corresponds to a particular delivery bin, and accordingly the delivery bin can be identified. Delivery vehicle identifier information can further be received the OHMD system corresponding to a delivery vehicle into which the delivery bin is being placed by the worker. The delivery management circuit and/or the OHMD system can evaluate the identified delivery bin and identified delivery vehicle relative to the delivery schedule and corresponding product orders to determine and/or confirm that the identified delivery bin is intended to be placed on the identified delivery vehicle and/or placed on the delivery vehicle in the order in which it is being placed. The delivery management circuit and/or OHMD system can cause a notification to be generated by the OHMD system notifying the worker when the delivery bin is being incorrectly placed into the delivery vehicle (e.g., placed into the incorrect delivery vehicle, placed into an incorrect compartment of a correct delivery vehicle, placed inconsistent with a loading sequence and/or order of loading.

Products from multiple different product orders can be pick from the isles and/or other areas of a retail store. The collected products subsequently are consolidated and/or distributed into respective different orders. Some embodiments utilize the OHMD systems to communicate with the consolidation management circuit and/or delivery management circuit to guide the workers to load the products to the different delivery bins in preparation for delivering the ordered products to the customer (e.g., customer retrieves the ordered products from the retail store, a delivery vehicle is used to deliver the ordered products to a delivery address, etc.). In some embodiments, the consolidation management circuit is part of a product order fulfillment system 100 that directed and/or control the collection and picking of products. Accordingly, the system has knowledge of and/or can determine in which pick container each collected product is located. The consolidation management circuit can cause an OHMD system to provide information to a worker identifying which pick container contains a product of interest to be put into which delivery bin. In some applications, the consolidation management circuit further has information about whether a product in a bag, a separate tote, bagged with different products, not in the same bag or same bin as one or more other products, and the like (e.g., the system has access to information defining which products can be in the same bag, and which products cannot be bagged with other products).

In some embodiments, the OHMD system is used to provide instructions to a worker. The instructions can be visually displayed, audibly presented (e.g., through speakers or headphones associated and/or part of the OHMD system). In some implementations, the OHMD system is connected with, controlled by and/or in communication with a user interface unit 122 (smart phone, tablet, other OHMD system, smart watch systems, and other such consumer electronic user devices) that may interact with the consolidation management circuit, delivery management circuit, and/or other components of the product order fulfillment system 100.

Through the OHMD system 104, the consolidation management circuit can validate each product is being placed in a correct delivery bin (e.g., image recognition of images captured by the one or more cameras of the OHMD system, optical scanning, RFID, or the like of each product and the corresponding delivery bin into which the product is placed). For example, the worker may retrieve a product that is identified by the OHMD system and/or consolidation management circuit, and be guided to an appropriate delivery bin. The retrieved product may, for example, be scanned through the camera of the OHMD system, and one or more images and/or video can be processed by the OHMD system and/or the consolidation management circuit to identify the product and determine delivery bin the product should be placed. Once placed into the delivery bin, the consolidation management circuit may registers the product as having been distributed in the specified delivery bin. This process of identifying a product and directing the worker to the correct delivery bin can be performed for any number of workers, and typically is performed simultaneously for multiple different workers, and can be repeated for each worker any number of times, and typically is repeated until all of the products for the multiple different product orders are accounted for and placed into delivery bins or otherwise staged to be placed into a delivery vehicle (e.g., some products may be too large to fit into a delivery bin, such as bulk products and other such large products).

Some embodiments further determine and/or optimize loading sequences. The loading sequences can take into consideration the delivery route, quantity of delivery bins (and other non-binned products that are being delivered), and number of delivery vehicles. The loading sequence in part identifies which delivery bins are loaded into which delivery vehicle. Further, some embodiments identify an order in which the delivery bins are loaded. For example, the delivery management circuit can take into consideration customers' areas, number of delivery bins, number of delivery vehicles, number of available drivers, and the like in computing delivery routes and order of delivery. Based the delivery routes and order of deliveries, the delivery management circuit can identify an order in which the delivery bins are to be loaded into which delivery vehicle. In some implementations, the delivery bins are loaded in accordance with a reverse order of delivery (e.g., one or more delivery bins that are scheduled to be delivered last are directed to be loaded into the delivery vehicle first, and one or more delivery bins to be delivered first are ordered to be loaded last). Some embodiments further take into consideration temperatures at which one or more products are to be maintained during delivery. The delivery scheduling and/or loading order can further take into consideration a number of frozen, cold, and ambient delivery bins that are part of each product order attempting to be delivered, and the space available in the corresponding frozen, cold, and ambient compartments of the delivery vehicle.

Once the optimized loading is determined, the OHMD system can be directed to guide the worker in selecting which delivery bin is to be loaded into which delivery vehicle and in which order to load. Further, some embodiments may further direct the worker to use one or more temperature controlled delivery bins and/or pack cooling and/or heating packets when the delivery vehicle does not include temperature controlled compartments and/or insufficient temperature control compartment space.

In some embodiments, the OHMD systems can provide feedback to the consolidation management circuit and/or delivery management circuit allowing the consolidation and vehicle loading processes to be tracked and confirm the accuracy of the consolidation, confirm accuracy of placement of the delivery bins and/or products into determined delivery vehicles and into correct compartments and/or correct racks within compartments consistent with a loading order. The confirmation can, in some applications, include scanning and/or identifying a delivery bin using the OHMD systems to verify the correct delivery bin or product being picked up, scan and/or identify through the OHMD systems the delivery vehicle to verify the delivery bin or product is being loading into the correct delivery vehicle, and in the correct compartment (e.g., frozen goods in frozen compartment, cool products in a cold compartment, ambient in ambient area's in the delivery vehicle, large products in a large product compartment, etc.) and correct rack of the compartment. When a discrepancy is detected the OHMD system can notify the worker. According, embodiments enable workers to consolidate and load products of multiple orders without the burden of paper work and hand held scanners, through the use of OHMD systems to provide visual and/or audio guidance on which products to consolidate and where to load product in a delivery vehicle.

In some embodiments, systems, apparatuses and methods are provided to fulfill product orders. Some embodiments comprise product order fulfillment systems, comprising: a plurality of optical head-mounted display (OHMD) systems; and a customer order fulfillment system associated with a retail store and configured to wireless communicate with each of the plurality of OHMD systems, and comprising a consolidation management circuit and memory storing computer instructions that when executed by the consolidation management circuit cause the consolidation management circuit to: receive multiple different product orders for one or more requested products to be fulfilled at the retail store; obtain, for each of multiple different pick containers into which multiple different picked products for the multiple different product orders were deposited by one or more workers, an identifier of each of the picked products in association with a pick container identifier of a respective one of the pick containers in which the picked product is located; identify, for each ordered product, a pick container identifier in which the ordered product is located; communicate to at least a first OHMD system associated with a first worker a consolidation listing identifying requested products corresponding to a first product order, the corresponding pick container identifier in which each of the requested products is located, and for each of the listed requested products a delivery bin identifier of a delivery bin into which the requested product is to be deposited in preparation for delivery of the first product order to a corresponding customer, and cause the consolidation listing to be displayed on the first OHMD system.

Some embodiments include methods of fulfilling product orders through a retail store, comprising: receiving, at a consolidation management circuit of a customer order fulfillment system associated with a retail store, multiple different product orders for one or more requested products to be fulfilled at the retail store; obtaining, for each of multiple different pick containers into which multiple different picked products for the multiple different product orders were deposited by one or more workers, an identifier of each of the picked products in association with a pick container identifier of a respective one of the pick containers in which the picked product is located; identifying, for each ordered product, a pick container identifier in which the ordered product is located; communicating to at least a first OHMD system associated with a first worker a consolidation listing identifying requested products corresponding to a first product order, the corresponding pick container identifier in which each of the requested products is located, and for each of the listed requested products delivery bin identifier information of a delivery bin into which the requested product is to be deposited in preparation for delivery of the first product order to a corresponding customer; and causing the consolidation listing to be displayed on the first OHMD system.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A product order fulfillment system, comprising:
a plurality of optical head-mounted display (OHMD) systems; and
a customer order fulfillment system associated with a retail store and configured to wireless communicate with each of the plurality of OHMD systems, and comprising a consolidation management circuit and memory storing computer instructions that when executed by the consolidation management circuit cause the consolidation management circuit to:
receive multiple different product orders for one or more requested products to be fulfilled at the retail store;
obtain, for each of multiple different pick containers into which multiple different picked products for the multiple different product orders were deposited by one or more workers, an identifier of each of the picked products in association with a pick container identifier of a respective one of the pick containers in which the picked product is located;
identify, for each ordered product, a pick container identifier in which the ordered product is located;
communicate to at least a first OHMD system associated with a first worker a consolidation listing identifying requested products corresponding to a first product order, the corresponding pick container identifier in which each of the requested products is located, and for each of the listed requested products a delivery bin identifier of a delivery bin into which the requested product is to be deposited in preparation for delivery of the first product order to a corresponding customer, and cause the consolidation listing to be displayed on the first OHMD system.

2. The system of claim 1, wherein the consolidation management circuit is further configured to:
receive an image from the first OHMD system of a first pick container;
identify, based at least in part on the image, each of multiple different products within the first pick container; and
cause the OHMD system to display a highlighting that visually distinguishes a first product of the multiple different products within the first pick container that corresponds to a first requested product identified in the consolidation listing.

3. The system of claim 1, wherein the consolidation management circuit is further configured to:
receive first product data from the first OHMD system and identify from the first product data a first product retrieved by the first worker from a first pick container;
confirm the product identifier information is consistent with a first requested product identified in the consolidation listing;
receive delivery bin data from the first OHMD system and identify from the delivery bin data a first delivery bin into which the first worker is placing the first product; and
confirm the first product is placed into the first delivery bin consistent with and as identified in the consolidation listing.

4. The system of claim 1, wherein the consolidation management circuit is further configured to:
obtain product identifier information of a first product retrieved by the first worker corresponding to the consolidation listing;
identify a first delivery bin into which the first product is to be placed; and
cause a notification to be generated by the first OHMD system notifying the first worker that the first product cannot be placed in a delivery bin with one or more other products already in the delivery bin.

5. The system of claim 1, further comprising:
a delivery management circuit coupled with memory that stores computer instructions that when executed by the delivery management circuit cause the delivery management circuit to:
determine a delivery route associated with a first delivery vehicle to perform delivery of the requested products for the multiple product orders;
identify, from the delivery route, a sequence of delivery of the multiple product orders;
determine a loading sequence of each delivery bin corresponding to the multiple product orders and the sequence of delivery; and
cause at least the first OHMD system to display an order of loading, consistent with the load sequence, in which the delivery bins corresponding to the multiple product orders are to be loaded into the delivery vehicle.

6. The system of claim 5, wherein the delivery management circuit in determining the load sequence is further configured to determine the load sequence in reverse order relative to the sequence of delivery such that one or more delivery bins associated with a product order scheduled to be delivered last are to be loaded into the delivery vehicle first, and one or more delivery bins associated with a product order scheduled to be delivered first are to be loaded into the delivery vehicle last.

7. The system of claim 5, wherein the consolidation management circuit in communicating the consolidation list is further configured to cause a notification to be generated by the first OHMD system notifying the first worker that a first product is to be placed in a first delivery bin that corresponds to a first product order and that corresponds to a first threshold temperature at which the first product is to be maintained; and
wherein the delivery management circuit in causing the first OHMD system to display the order of loading is further configured to cause the first OHMD system to display a compartment identifier of a compartment on the delivery vehicle consistent with the threshold temperature into which the first delivery bin is to be placed.

8. The system of claim 5, wherein the delivery management circuit is further configured to:
receive delivery bin identifier information from the first OHMD system corresponding to a first delivery bin and identify the first delivery bin;
receive delivery vehicle identifier information from the first OHMD system corresponding to the first delivery vehicle into which the first delivery bin is being placed by the first worker; and
cause a notification to be generated by the first OHMD system notifying the first worker when the first delivery bin is being incorrectly placed into the first delivery vehicle.

9. A method of fulfilling product orders through a retail store, comprising:
receiving, at a consolidation management circuit of a customer order fulfillment system associated with a retail store, multiple different product orders for one or more requested products to be fulfilled at the retail store;
obtaining, for each of multiple different pick containers into which multiple different picked products for the multiple different product orders were deposited by one or more workers, an identifier of each of the picked products in association with a pick container identifier of a respective one of the pick containers in which the picked product is located;
identifying, for each ordered product, a pick container identifier in which the ordered product is located;
communicating to at least a first OHMD system associated with a first worker a consolidation listing identifying requested products corresponding to a first product order, the corresponding pick container identifier in which each of the requested products is located, and for each of the listed requested products delivery bin identifier information of a delivery bin into which the requested product is to be deposited in preparation for delivery of the first product order to a corresponding customer; and
causing the consolidation listing to be displayed on the first OHMD system.

10. The method of claim 9, further comprising:
receiving an image from the first OHMD system of a first pick container;
identifying, based at least in part on the image, each of multiple different products within the first pick container; and
causing the OHMD system to display a highlighting that visually distinguishes a first product of the multiple different products within the first pick container that corresponds to a first requested product identified in the consolidation listing.

11. The method of claim 9, further comprising:
receiving first product data from the first OHMD system and identifying from the first product data a first product retrieved by the first worker from a first pick container;
confirming the product identifier information is consistent with a first requested product identified in the consolidation listing;
receiving delivery bin data from the first OHMD system and identifying from the delivery bin data a first delivery bin into which the first worker is placing the first product; and
confirming the first product is placed into the first delivery bin consistent with and as identified in the consolidation listing.

12. The method of claim 9, further comprising:
obtaining product identifier information of a first product retrieved by the first worker corresponding to the consolidation listing;
identifying a first delivery bin into which the first product is to be placed; and
causing a notification to be generated by the first OHMD system notifying the first worker that the first product cannot be placed in a delivery bin with one or more other products already in the delivery bin.

13. The method of claim 9, further comprising:
determining a delivery route associated with a first delivery vehicle to perform delivery of the requested products for the multiple product orders;
identifying, from the delivery route, a sequence of delivery of the multiple product orders;
determining a loading sequence of each delivery bin corresponding to the multiple product orders and the sequence of delivery; and
causing at least the first OHMD system to display an order of loading, consistent with the load sequence, in which the delivery bins corresponding to the multiple product orders are to be loaded into the delivery vehicle.

14. The method of claim 13, wherein the determining the load sequence further comprises determining the load sequence in reverse order relative to the sequence of delivery such that one or more delivery bins associated with a product order scheduled to be delivered last are to be loaded into the delivery vehicle first, and one or more delivery bins associated with a product order scheduled to be delivered first are to be loaded into the delivery vehicle last.

15. The method of claim 13, wherein the communicating the consolidation list further comprises causing a notification to be generated by the first OHMD system notifying the first worker that a first product is to be placed in a first delivery bin that corresponds to a first product order and that corresponds to a first threshold temperature at which the first product is to be maintained; and
wherein the causing the first OHMD system to display the order of loading further comprises causing the first OHMD system to display a compartment identifier of a compartment on the delivery vehicle consistent with the threshold temperature into which the first delivery bin is to be placed.

16. The method of claim 13, further comprising:
receiving delivery bin identifier information from the first OHMD system corresponding to a first delivery bin and identify the first delivery bin;
receiving delivery vehicle identifier information from the first OHMD system corresponding to the first delivery vehicle into which the first delivery bin is being placed by the first worker; and
causing a notification to be generated by the first OHMD system notifying the first worker when the first delivery bin is being incorrectly placed into the first delivery vehicle.
